(19) United States
(12) Patent Application Publication
(10) Pub. No.: US 2008/0190257 A1
(43) Pub. Date: Aug. 14, 2008

(54) Apparatus for Gripping and Severing Film-Like Materials

(75) Inventor: Peter Bruce Hanmer, Queensland (AU)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Wrap Film Systems Limited

(21) Appl. No.: 11/885,064

(22) PCT Filed: Feb. 26, 2005
(86) PCT No.: PCT/GB05/00748

§ 371 Date: Nov. 5, 2007

(51) Int. Cl. B26D 7/00

(52) U.S. Cl. 83/649

(57) ABSTRACT

Apparatus for gripping pliable sheet materials including at least first and second elongated substantially linear jaw members, the first jaw member being complementary to second jaw member, and a mounting device for mounting the first jaw member to allow it to conform longitudinally to the second jaw member to enable the material to be clamped fully along the length of the jaw members. Typically the gripping apparatus is incorporated in a dispenser and the gripping apparatus includes a pair of upper jaw members and a pair of complementary lower jaw members between which the material may be gripped for severing by a severing blade.

### TECHNICAL FIELD

The invention relates to apparatus for gripping film-like materials such as films of plastics materials, foil or other thin pliable material. The present invention finds particular application in dispensers from which material from a roll such as plastics material, foil or paper material may be severed and dispensed however the apparatus may be used in other applications where gripping of thin pliable materials is required.

### BACKGROUND ART

Plastics sheet material and paper sheet material for use by consumers is usually carried on a cylindrical former and stored inside a container or carton having a closure flap which may be opened to expose the sheet material for cutting on serrated knife-edge provided on the container or carton. Apparatus has been proposed for facilitating the dispensing of such materials such as the apparatus disclosed in the current inventor's European Patent No. 0 324 752 and U.S. Pat. No. 5,107,732. In the apparatus disclosed in that patent, upper and lower jaw carriers are provided with each having elongated jaw members extending therealong, the jaw members on one carrier having a profile complementary to that of the jaw members on the other carrier such that the complementary jaw members can engage and stretch the material for severing by severing means between the jaw members of one carrier which are movable relative to the jaw members.

The elongated jaw members are usually formed of plastics and difficulties have been encountered in ensuring that the complementary jaw members match each other and therefore clamp the material to be severed along its length. Usually the jaw members are 200 to 500 mm long and it is almost impossible to ensure that the jaw members form a longitudinal straight edge. If the jaw members do not match perfectly, they will not fully clamp the material to be severed along its width. Portions of the material which are not fully clamped between the jaw members will slip during the severing process and an unclean cut will result. This is a particular problem where the sheet material to be cut is a thin plastics film.

Whilst a rubberised or similar finish can be applied to one or both jaw members to compensate for longitudinal imperfections in the jaw members, jaw members of this type can tend to jam upon engagement with the other jaw member. In addition if one of the jaw members is formed of metal such as aluminium and the other jaw member is formed from, or coated with, a flexible material such as rubber or PVC, plastics film material tends to build up static electricity as it is pulled out of the dispensing apparatus and from its roll. This can result in sparking between the operator grasping the film and the metallic jaw. Further in this configuration, the jaw members do not function particularly efficiently in clamping the film and in addition the two jaw members tend to jam together.

When aluminium foil is being dispensed, a problem arises when the foil is guided between a pair of upper and lower holding tongues. In such situations, the surface of at least the holding tongue tends to become rapidly polished. When this occurs, the tongues become unsuitable for holding plastic film and are required to be etched to make them again suitable.

### SUMMARY OF THE INVENTION

The present invention aims to provide an improved apparatus for gripping pliable sheet materials such as thin film materials. The apparatus of the invention is particularly suited to gripping pliable sheet materials to allow effective severing thereof The apparatus of the invention however may be applied to any application where gripping of a pliable sheet material along an extended length is required. The present invention in a further aspect aims to provide dispensing apparatus for dispensing sheet materials which incorporates the gripping apparatus. Other objects and advantages of the invention will become apparent from the following description.

The present invention thus provides in a first preferred aspect, apparatus for gripping pliable sheet materials, said apparatus including first and second elongated substantially linear jaw members, said first jaw member being complementary to said second jaw member and means for mounting one said jaw member in such a manner as to allow said one jaw member to conform longitudinally to the other said jaw member whereby said material may be gripped along the length of said jaw members.

Preferably, the mounting means for the one jaw member mount the one jaw member in such a manner as to allow it to conform along its length to the other jaw member. Preferably, the mounting means provide a mount for the one jaw member intermediate its length such that opposite ends of the one jaw member are free for limited movement in at least in a direction transverse to the length of the jaw member and towards or away from the other jaw member. Preferably the mounting means also permit limited movement of the one jaw member intermediate its length in a lateral direction transverse to its length. Preferably the mounting means comprises a pair of spaced mounts suitably provided symmetrically intermediate the opposite ends of the one jaw member permitting limited movement of the free ends of the one jaw member and also permitting limited transverse movement of the one jaw member intermediate the mounts towards and away from the other jaw member. Typically the mounts are arranged approximately one-third along the length of the one jaw member from opposite ends thereof.

The other jaw member suitably comprises an elongated jaw member which is mounted only at its opposite ends. This will permit the other jaw member to bend or deflect intermediate its ends. The one jaw member will thus be capable of matching the other jaw member longitudinally. The jaw member may also bend laterally to match the other jaw member.

Preferably one of the jaw members comprises a male jaw member and the other of the jaw member comprises a female jaw member. The female jaw member may include a recess to receive the male jaw member which suitably includes a portion substantially complementary to the shape of the recess of the female jaw member. The female jaw member may be defined by opposite elongated fingers which define the recess therebetween. The elongated opposite fingers are suitably capable of limited movement away from each other so as to be capable of deflection to match the male jaw member.

Typically, the jaw members are arranged in a dispenser for dispensing sheet material and for gripping the sheet material for severing thereof. Usually the material to be dispensed is supplied on a roll of material carried on a cylindrical former. The sheet material may be paper or paper based, metal foil such as aluminium foil or plastics material such as food wrap or plastics material for other purposes.

Thus in a further aspect, the present invention provides a dispenser for dispensing thin pliable sheet material, said dispenser including means for gripping said sheet material, said gripping means including first and second pairs of elongated substantially linear jaw members, said jaw members of said one pair being complementary to the jaw members of said other pair, said jaw members being supported for movement relatively towards each other to grip said material therebetween, and means for mounting the jaw members of one said pair in such a manner as to allow said jaw members of said one pair to conform longitudinally to the jaw members of the other said pair whereby said material may be clamped along the length of said jaw members, and means for severing said material gripped between said first and second pairs of jaw members.

Preferably the jaw members of the one pair are mounted at their opposite ends so that they are capable of bending or deflecting intermediate their ends to match longitudinally the jaw members of the other pair. Preferably the jaw members of the other pair are free at their opposite ends for limited movement towards and away from the jaw members of the one pair. The jaw members of the other pair are also preferably free for limited lateral movement relative to the jaw members of the one pair to match laterally the jaw members of the one pair.

The mounting means for the first and second pairs of jaw members suitably comprise respective jaw carriers upon which the respective pairs of jaws are supported and carried, the jaw carriers being mounted for movement relatively to one another. The jaw carriers suitably comprise upper and lower jaw carriers, each carrying a pair of jaw members.

Suitably, the jaw members supported on the upper carrier are spaced apart to define a recess therebetween. The jaw members extend outwardly from the upper carrier and are directed towards the jaw members on the lower carrier.

The upper carrier may be pivotally mounted for movement relative to the lower carrier and the upper carrier may be normally biased away from the lower carrier.

The jaw members supported on the lower carrier are also suitably spaced apart to define a recess therebetween.

The severing means for severing the material are suitably located in the recess between the jaw members supported on the lower or upper carrier. The jaw members between which the severing means is located are suitably mounted by or to their carrier so as to normally conceal the severing means but being movable relative to the severing means to expose the severing means for severing the material.

Preferably the severing means is located in a recess between the jaw members on the lower carrier. Preferably the jaw members on the lower carrier are suitably mounted independently to the lower carrier and biasing means are provided to bias said jaw member to a position to normally conceal the severing means.

Suitably the jaw members on one of the carriers have recesses to receive the complementary jaw members on the other carrier.

The severing means suitably comprises a cutting member extending substantially parallel to the jaw members and is mounted relative to the jaw members for movement between a retracted and concealed non-cutting position to an extended and exposed cutting position. The cutting member may be caused to move from the retracted to the extended position as a consequence of cooperation between the upper and lower jaw carriers. Preferably the cutting member is brought into contact with the material as the jaw members of the upper and lower carriers engage.

Preferably the cutting member is an elongate cutting blade. Preferably the cutting blade has a plurality of triangular outwardly extending cutting teeth for engaging the material. The teeth may first pierce the material and then cut the material as the blade is moved into the material.

Preferably the material to be dispensed from the dispenser passes over a roller which reduces or minimises static electricity in the material. The roller suitably comprises a roller formed of metal such as aluminium. The material suitably also passes between a pair of holding members or tongues which cooperate to hold the material for gripping by hand to facilitate its withdrawal from the dispenser.

### BRIEF DESCRIPTION OF THE DRAWINGS

In order that the invention may be more readily understood and put into practical effect, reference will now be made to the accompanying drawings which illustrate a preferred embodiment of the invention in which the gripping apparatus has been described for use in a dispenser for dispensing plastic film. The gripping apparatus may be used in many different gripping applications. In the drawings:

FIG. 1 is an end view of a dispenser incorporating film gripping apparatus according to an embodiment of the invention;

FIG. 2 is an enlarged part sectional view of the dispenser of FIG. 1 with jaw carriers carrying the jaw members of the gripping apparatus in a normal open position;

FIG. 3 is a perspective view of the jaw members carried by the upper and lower jaw carriers of the dispenser;

FIG. 4 is an enlarged sectional view of the upper and lower jaw members approaching an engaged position; and

FIG. 5 is an enlarged cross sectional view along line X-X of FIG. 3.

### DETAILED DESCRIPTION OF THE DRAWINGS

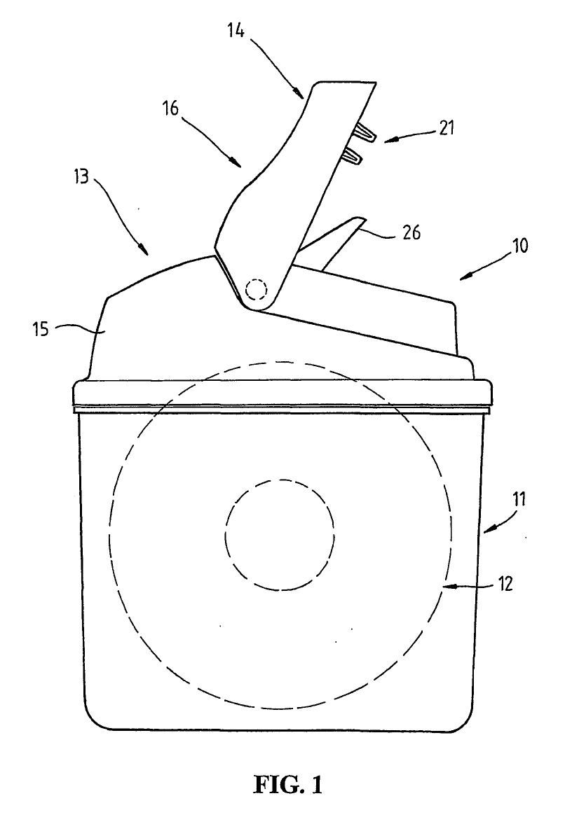

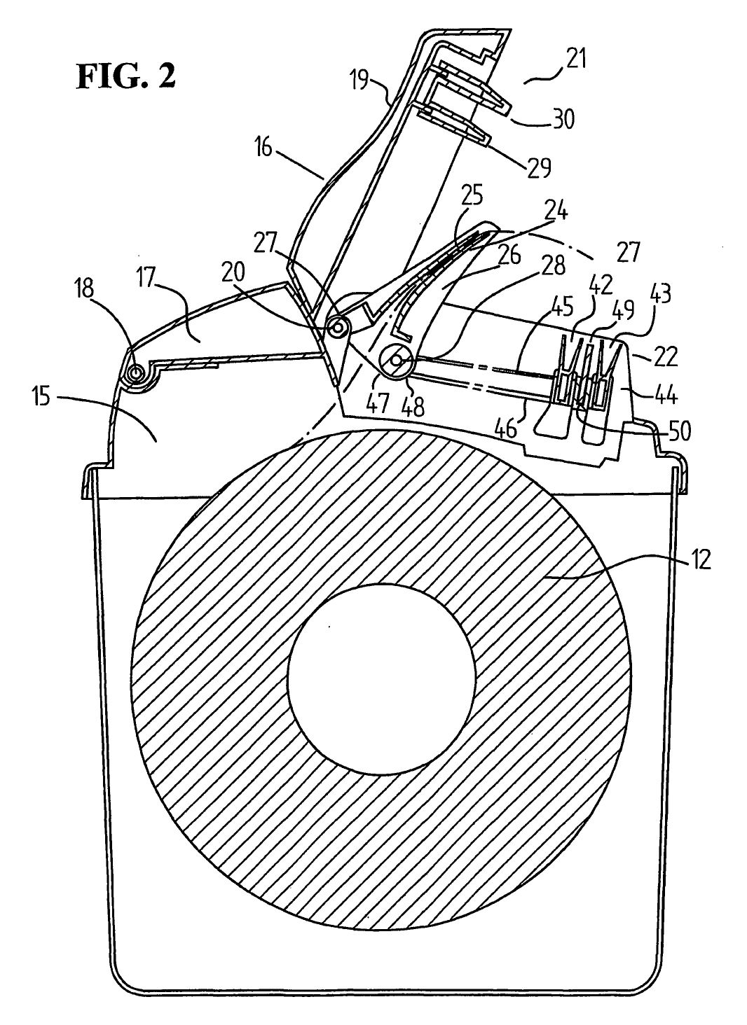

Referring to the drawings, FIG. 1 illustrates a typical dispenser 10 of pliable sheet material such as a film of plastics material which incorporates gripping apparatus according to an embodiment of the invention. The dispenser 10 has a hollow elongated rectangular base 11 in which a roll 12 of pliable material such as plastics film (shown in dotted outline) for dispensing from the dispenser 10 is supported rotatably by means of end supports for rotational movement about its longitudinal axis. The dispenser 10 additionally includes an upper cover 13 incorporating a severing mechanism indicated generally at 14, the cover 13 seating detachably on the base 11. The cover 13 as more clearly shown in FIG. 2 includes a fixed body part 15 and an upper jaw carrier 16 which comprises a first part 17 pivotally coupled to the cover body part 15 at pivot 18 and a second jaw carrier part 19 pivotally coupled to the first part 17 at pivot 20. The dispenser 10 in FIGS. 1 and 2 is shown in its rest position with jaw carrier part 19 biased away from the forward end 11 of the body part 15 by springs associated with the pivot 20.

The cover 13 of the dispenser 10 incorporates gripping apparatus comprising upper jaws 21 and lower jaws 22 (described further below) which can cooperate to grip and clamp the material from the roll 12 to be severed and dispensed from the dispenser 10. A free edge 23 of the roll material passes out between lower and upper elongated holding member or tongues 24 and 25 which are biased towards each other to grip therebetween the thin pliable material to present the free edge 23 to be readily grasped by a user to enable the material to be withdrawn from the roll 12 for severing. The lower holding member 24 is fixed to the arms 26 at opposite ends of the dispenser 10 which are pivotally connected at pivot 27 aligned with the pivot 20 to the cover 13. Biasing means such as springs associated with the pivot 27 normally bias the arms 26 and thus the lower holding member 24 upwardly towards the upper holding member 25. The upper holding member 25 is pivotally mounted to the upper jaw carrier part 16 at pivot connections 20 and is free for limited pivotal movement as described further below.

A roller 28 is also supported between the arms 26, the roller 28 extending substantially parallel to the lower holding member 24 and being mounted to the arms 26 at opposite ends for rotation about a longitudinal axis. The roller 28 is positioned to the rear of the lower holding member 24. Typically the roller 28 is a hollow tubular member and formed of aluminium. The material to be dispensed from the roll 12 is in contact with and passes over the roller 28 to be guided between the upper and lower holding members 25 and 24 as illustrated in FIG. 2.

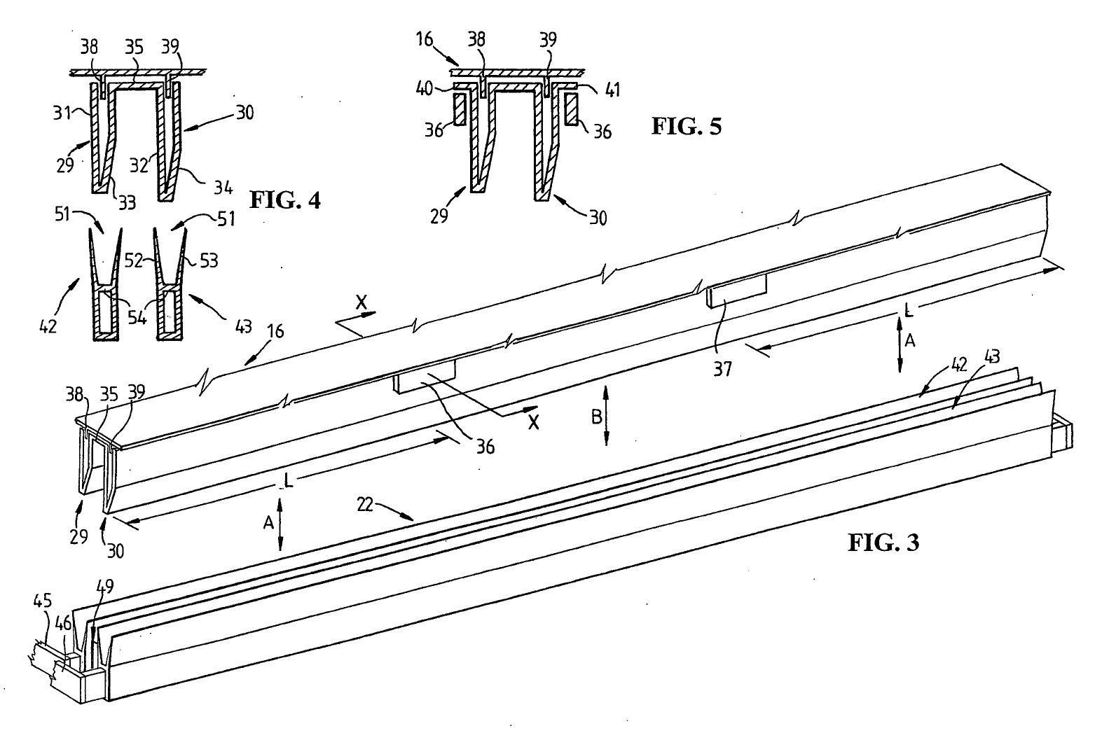

The upper jaw 21 comprises a pair of jaw members 29 and 30 which depend downwardly from the jaw carrier part 19 and extend longitudinally substantially the full length of the dispenser 10 from one end of the dispenser 10 to the other end. The outer jaw member 30 projects outwardly from the jaw carrier part 19 a distance greater the inner jaw member 29. The jaw member 30 thus leads the jaw member 29. The jaw members 29 and 30 as shown more clearly in FIGS. 3 to 5 taper in cross section towards their free outer ends such that the free ends have a substantially V-shaped cross sectional configuration. The corresponding sides 31 and 32 of each jaw member 29 and 30 are substantially planar and the opposite sides 33 and 34 of each jaw member 29 and 30 are tapered towards the free ends of the jaw members 29 and 30 to form the V-shaped cross section of the jaw members 29 and 30. As illustrated the jaw members 29 and 30 are formed integrally and joined through a bridging web 35 and furthermore are internally hollow and open on their ends opposite their leading ends.

The jaw members 29 and 30 are mounted to the carrier part 16 by spaced mounts 36 and 37 on opposite sides of the jaw members 29 and 30. Furthermore the jaw carrier part 16 is provided with elongated parallel ribs 38 and 39 which project into the internal hollow of the jaw members 29 and 30 from their undersides to provide lateral guidance to the jaw members 29 and 30. The jaw members 29 and 30 also include opposite outwardly extending flanges 40 and 41 at a distance L from opposite ends of the jaw members 29 and 30, the distance L being approximately one-third of the length of the jaw members 29 and 30. The flanges 40 and 41 extend beneath the opposite side mounts 36 and 37 and anchor the jaw members 29 and 30 to the jaw carrier part 16 only at those positions. The opposite ends of the jaw members 29 and 30 are spaced from the carrier part 16 and are free for limited movement towards and away from the carrier part 16 as indicated by the arrows A in FIG. 3. Similarly the jaw members 29 and 30 between the mounts 36 and 37 are free for movement towards or away from the carrier member part 16 as indicated by the arrow B. Lateral movement of the jaw members 29 and 30 however is limited by the ribs 38 and 39.

The lower jaw 22 comprises a pair of lower jaw members 42 and 43 complementary to the upper jaw members 29 and 30 which are mounted on a jaw carrier 44 connected to the body part 15 of the cover 13, the jaw carrier 44 including pairs of arms 45 and 46 at opposite ends of the dispenser 10. One pair of arms 45 shown in dotted outline in FIG. 2 are rigidly fixed to opposite ends of the rear jaw member 42 and are pivotally mounted to the carrier 44 by a pivot connection shown generally at 47 defining a pivot axis for movement of the jaw member 42 which extends generally parallel to the jaw member 42. The other pair of arms 46 are fixed to opposite ends of the front jaw member 43, the arms 46 being similarly pivotally mounted to the carrier 44 by a pivot connection shown generally at 48 defining a pivot axis for movement of the jaw member 43 which extends generally parallel to the jaw member 43. The jaw members 42 and 43 are thus independent of each other. The arms 45 and 46 of each jaw member 42 and 43 are biased upwardly by springs (not shown) at the pivot axes 47 and 48 of the arms 45 and 46 to normally bias the lower jaw members 42 and 43 upwardly towards the upper jaw members 29 and 30 to the position of FIG. 2. Such an arrangement is similar to that disclosed in the aforesaid U.S. Pat. No. 5,107,732.

A blade 49 is located between the jaw members 42 and 43 and extends substantially parallel to the jaw members 42 and 43. The blade 49 is held by an elongated holder 50 which is mounted on the body part 15 of the cover 13 so that the blade 49 is fixed relative to the jaw members 42 and 43. Further the blade 49 is concealed between the jaw members 42 and 43 when in the rest position of FIG. 2. The blade 49 (although not apparent in FIG. 2) has a serrated cutting profile with upstanding saw teeth.

Both of the jaw members 42 and 43 are formed with tapered recesses 51 at their distal ends for receipt of and cooperation with the upper jaw members 29 and 30, the tapering recesses 51 being of a V-shaped configuration substantially complementary shape to the leading ends of the jaw members 29 and 30. The recesses 51 are defined by side flanges or fingers 52 and 53 which are of a tapered profile and which are joined by a thin web 54 which allows some flexing of the flanges 52 and 53. The included angle of the grooves 51 defined between the flanges 52 and 53 is slightly less than the angle of taper of the jaw members 29 and 30 such that when the jaw members 42 and 43 receive the jaw members 29 and 30, the material from roll 12 located between the jaw members 42 and 43 and 29 and 30 is not only stretched to span between jaw members 29 and 30 but is also securely held or clamped between these members and the jaw members 42 and 43. Furthermore the nature of the mounting of the jaw members 29 and 30 ensures that the members 29 and 30 adjust in the directions A and/or B to match the longitudinal profile of the jaw members 42 and/or 43. Thus in the case of any non-linearity of the jaw members 42 and 43, the jaw members 29 and 30 will adjust to the non-linearity and ensure complete and continuous clamping of the material along the length of the jaw members 29 and 30.

The space between the jaw members 29 and 30 receives the blade 49 when the jaw carrier part 16 is pressed downwardly towards the body 11. Pressing of the jaw carrier part 16 downwardly initially causes the upper jaw member 30. (which leads the jaw member 29) to enter the recess 51 in the jaw member 43 and thus grip the material from the roll 12 therebetween Thereafter the jaw member 29 enters the recess 51 in the jaw member 42 which causes tension to be applied to the material gripped between the respectively pairs of jaw members 30 and 43 and 29 and 42 respectively. The arms 45 and 46 which support the jaw members 42 and 43 are also urged downwardly about their pivot connections 47 and 48 when the jaw member 29 and 30 seat in the jaw members 42 and 43 so that the blade 49 is moved relatively towards the material gripped between the jaw members 42 and 43 and 29 and 30 to engage and sever a length of material from the roll 12 as the material is moved relatively towards and over the blade 49. Since the material is securely held and stretched by jaw members 42, 43 and 29, 30, the blade 49 (with its saw tooth serrations) can cleanly sever a discrete length of material from the roll 12. The complementary wedge shapes of the jaw members 29 and 42, and 30 and 43, ensures that maximum grip is afforded for minimum effort. As stated above, the tapers on the jaw members 29 and 30 are slightly greater than the tapers of the recesses 51 in the jaw members 42 and 43 such that the material is stretched as it is gripped between the cooperating jaw members to ensure that the operation of the blade is quick and easier.

As the film passes over the roller 28 from the roll 12 and is drawn from the dispenser 10 it will be guided smoothly from the dispenser 10. Further the build up of static electricity is reduced. A further advantage is that when the dispenser is used for aluminium foil, the roller 28 prevents the surface of the lower holding member or tongue 24 from being polished so as to retain the suitability of the apparatus for dispensing film.

It should be appreciated that in an alternative embodiment, the blade 49 may be associated with the jaw carrier 13 and positioned between the jaw members 29 and 30. Similarly, the jaw members 29, 30 and 42, 43 may have their relative locations transposed. In another embodiment, the jaw members 42 and 43 may be mounted on a common arm instead of being mounted on separate arms 47 and 48.

All other modifications as would be apparent to persons skilled in the art are deemed to fall within the broad scope and ambit of the invention as herein set forth in the appended claims.

1. A severing apparatus for gripping and severing pliable sheet materials, said apparatus including severing blade and at least a male and a female elongated substantially linear jaw members, said female jaw members having in cross section a V-shaped recess to receive a portion of the male jaw member, said male jaws member including a V-shaped portion substantially complementary to the recess of the female jaw member, said recess being defined by opposite elongated flanges which are joined by a thin web, which allows some flexing of the flanges so as to be capable of deflection to match the male jaw member, the included angle of said V-shaped recess defined by flanges being slightly less than the angle of taper of the male jaw member, whereby said material may be gripped along the length of said jaw members.

2. A severing apparatus as claimed in claim 1, wherein it comprises means for mounting said jaw members in such a manner as to allow said male jaw member to conform longitudinally to said female jaw member.

3. A severing apparatus as claimed in claim 2 wherein said mounting means mount one jaw member in such a manner as to allow it to conform along its length to the other jaw member.

4-30. (canceled)

31. A severing apparatus as claimed in claim 3 characterised in that said mounting means for one jaw members is provided intermediate the length of said jaw member such that opposite ends of said one jaw member are free for limited movement in at least one direction transverse to the length of the jaw member and towards and away from the other jaw member.

32. A severing apparatus as claimed in claim 31 characterised in that said mounting means permit limited movement of said one jaw member intermediate its length in a lateral direction transverse to its length.

33. A severing apparatus as claimed in claim 3 characterised in that said mounting means comprise a pair of spaced mounts.

34. A severing apparatus as claimed in claim 33, wherein said mounts are provided symmetrically intermediate the opposite ends of the one jaw member.

35. A severing apparatus as claimed in claim 34 characterised in that said mounts are arranged approximately one third along the length of the one jaw member from opposite ends thereof.

36. Apparatus as claimed in claim 1 characterised in that said other jaw member is mounted only at its opposite ends whereby to permit the other jaw member to bend intermediate its ends.

37. A severing apparatus as claimed in claim 1, comprising a pair of said male jaw member and a pair of said female jaw members.

38. A severing apparatus as claimed in claim 37, wherein said pairs of jaw members are respectively mounted onto a lower jaw carrier and an upper jaw carrier.

39. A severing apparatus as claimed in claim 38, wherein said severing blade is located in a recess between a pairs of jaw members supported on the lower or the upper carrier.

40. A severing apparatus as claimed in claim 37, wherein said first and second pairs of jaw members are supported on respective jaw carriers mounted for movement relatively to one another.

41. A severing apparatus as claimed in claim 39, wherein said jaw carriers comprise upper jaw carriers and lower jaw carriers, and wherein said jaw members supported on said upper jaw carrier are spaced apart to define a recess there between and extend outwardly from the upper jaw carrier.

42. A severing apparatus as claimed in claim 39 characterised in that the jaw members on the lower jaw carrier are spaced apart to define a recess there between, said severing blade being provided in said recess and wherein said jaw members on said lower jaw carrier are mounted by or to their carrier to normally conceal said severing blade, said jaw members on said lower jaw carrier being supported for independent movement on support arms mounted for pivotal movement about pivot axes.

43. A severing apparatus as claimed in claim 1 characterised by a roller over which material to be severed may pass to reduce or minimises static electricity in the material.
